(19) United States
(12) Patent Application Publication
(10) Pub. No.: US 2026/0262140 A1
(43) Pub. Date: Sep. 3, 2026

(54) METHOD AND SYSTEM FOR TEMPERATURE CONTROLLED PRE-SPINNING OF ROTOR FORGINGS

(71) Applicant: Schenck USA Corp., Deer Park, NY (US)

(72) Inventors: Hiroaki ENDO, Douglas, MA (US); Cameron DEWALLACE, Hudson, MA (US); David WOODFORD, Hudson, MA (US)

(73) Assignee: Schenck USA Corp., Deer Park, NY (US)

(21) Appl. No.: 19/066,377

(22) Filed: Feb. 28, 2025

(51) Int. Cl. H05B 6/10; C21D 1/42

(52) U.S. Cl. CPC H05B 6/10; C21D 1/42

(57) ABSTRACT

A method and apparatus for temperature controlled pre-spinning of rotor forgings is provided. The apparatus includes a spin pit configured to receive a rotor forging; a drive unit and a transmission assembly operable to spin the rotor forging at a high rotational speed within the spin pit; a coolant pipe configured to extend through a central bore of the rotor forging; a bore coolant assembly operable to circulate coolant through the coolant pipe; a vacuum pump operable to create a vacuum in the spin pit; a plurality of rim heater units installed within the spin pit around a circumference of the rotor forging; and a controller operable to monitor and control a spin speed, a spin duration, a vacuum pressure and/or a temperature of the rotor forging at different areas of the rotor forging.

### BACKGROUND OF THE INVENTION

### Field of the Invention

The invention relates to a method and apparatus for temperature controlled pre-spinning of rotor forgings.

### The Prior Art

The manufacture of disks for gas turbine and jet engine rotors includes a number of intricate steps before the disk is machined to a final shape. Typically the disks are formed by a forging process and the forged disks then undergo a heat treatment process to achieve the desired mechanical properties in the disk.

Although the heat treatment processes for forged disks are generally efficient, existing heat treatment processes are known to result in undesirable variations in the residual stresses in the disk and the mechanical properties of the disk. In particular, depending on certain inherent process variables during the heat treatment process, for example the location of the disk in the oven and the method of heating and cooling, a non-uniform distribution of disk material properties and residual stresses is produced. The negative impacts of these variations include incurring increased machining costs due to the warping and undesirable distortion of the disks, suffering loss of engine performance due to the inability to predict and control the blade tip clearance, and the requirement of shorter engine maintenance intervals to account for the not fully understood effect of the variation on the fatigue life of the part.

In recent years, a process known as pre-spinning (also known as overspeed testing or proof spin testing) was introduced to remedy the undesirable effects of the above-mentioned material property variations. During this process, the material of a forged and heat treated rotor disk is conditioned by proof spinning a semi-finished, near-net shape disk into the yield region of the material. During the pre-spinning process, the disks are proof spun in a spin pit to a prescribed speed (typically slightly above a plastic regime) in an ambient vacuum environment.

Spinning the disk provides a more uniform distribution of residual stress states in the disk, thereby correcting the variations resulting from the heat treatment process mentioned above. The pre-spinning process preferentially yields the lower strength areas and equalizes the global material properties, resulting in more homogeneous material strengths. The more homogenously distributed residual stress and material strength properties produced by the pre-spinning process benefit the subsequent machining operation by minimizing material movement (warpage). This process also introduces favorable residual compressive stress in the bore of the disk which lower the mean stress during cycling and improve the structural stability and fatigue life of the part in operation.

Certain restrictions present in the existing pre-spinning processes relate to the limited variables influencing the results of the manufacturing process, which restrictions limit the ability to optimize the material properties of the manufactured disks. For example, the existing pre-spinning processes use the mass (or the shape) of the disk and the spin speed to target the location and the magnitude of yielding in the disks in order to influence the residual stress state and the material and mechanical properties of the disk.

Existing processes (heat treatment and pre-spinning in a sequence) result in a significant number of disks that are non-conforming due to variations in the material properties, for example, a rotor forging may grow above or below a target dimension after pre-spinning. Consequently, the non-conforming rotor forging may sit around for months, which is very costly. Although a number of the non-conforming rotor forgings may ultimately be approved and used, the 4-12 month non-conformance period is significant. In particular, the resulting interruption in the production line results in significant costs.

Accordingly, a need exists for a pre-spinning system and process which enables the achievement of superior material property results in the disk. Moreover, a need exists for a pre-spinning system and process capable of preferentially inducing both the location and magnitude of plasticity in the disk, thereby enabling optimization of the pattern of bulk residual stresses, enhancing the disk structural stability, durability, and strength and providing superior disk burst speed and fatigue life.

### SUMMARY OF THE INVENTION

The invention relates to a method and apparatus for temperature controlled pre-spinning of rotor forgings.

A method for temperature controlled pre-spinning of rotor forgings according to an embodiment of the invention includes the step of providing a pre-spin machine having a drive unit and a transmission assembly operable to spin a rotor forging at a high rotational speed, a spin pit, a coolant pipe configured to extend through a central bore of the rotor forging, a bore coolant assembly operable to circulate coolant through the coolant pipe, a vacuum pump operable to create a vacuum in the spin pit and one or more controllers operable to monitor and control one or more of a spin speed, a spin duration, a vacuum pressure and a temperature of the rotor forging at different areas of the rotor forging. The rotor forging is mounted in the spin pit of the pre-spin machine and a plurality of rim heater units is installed around a circumference of the rotor forging. The spin pit is closed and a vacuum is created in the spin pit with the vacuum pump. The rotor forging is spun to a rotational speed lower than a target speed and the central bore is cooled to a predetermined temperature using the bore coolant assembly. The rim heater units are activated to heat an area about the circumference of the rotor forging. The temperature of the area about the circumference of the rotor forging is monitored and the area is heated until the temperature of the area reaches a target temperature. The temperature at the area about the circumference of the rotor forging, a temperature at a web of the rotor forging and a temperature at the central bore of the rotor forging are monitored until a predetermined stable temperature profile of the rotor forging is reached. The rotational speed of the rotor forging is increased to the target speed. The rim heater units are deactivated, the rotation of the rotor forging is stopped and the rotor forging is removed from the spin pit.

In a further embodiment, the step of installing the plurality of rim heater units includes installing a plurality of induction heating units, wherein each induction heating unit has a ceramic casing, a susceptor, a plurality of induction coils and a fluid purge cooler.

In another embodiment, the rotor forging is maintained at the target speed for a specified dwell duration time and the step of deactivating the rim heater units is performed when the specified dwell duration time is met.

In another embodiment, the specified dwell duration time at the target speed is in the range of 0 – 24 hours.

In another embodiment, the method further includes the step of installing a plurality of rim cooler units around the circumference of the rotor forging.

In another embodiment, the plurality of rim heater units and rim cooler units are collectively operable to cool or heat the area about the circumference of the rotor forging to a temperature in a range of - 321 degrees Fahrenheit to 2,300 degrees Fahrenheit.

In another embodiment, the rim cooler units are activated to quench the rotor forging.

In another embodiment, at least one of the temperature at the area about the circumference of the rotor forging, the temperature at the web of the rotor forging and the temperature at the central bore of the rotor forging is monitored until a predetermined temperature is reached and the rim cooler units are then deactivated.

In another embodiment, the vacuum created in the spin pit has a vacuum pressure of less than 600 mTorr.

In another embodiment, the rotor forging is spun at a rotational speed of 0 – 150,000 revolutions per minute.

An apparatus for temperature controlled pre-spinning of rotor forgings according to an embodiment of the invention includes a spin pit configured to receive a rotor forging; a drive unit and a transmission assembly operable to spin the rotor forging at a high rotational speed within the spin pit; a coolant pipe configured to extend through a central bore of the rotor forging; a bore coolant assembly operable to circulate coolant through the coolant pipe; a vacuum pump operable to create a vacuum in the spin pit; a plurality of rim heater units installed within the spin pit around a circumference of the rotor forging; and one or more controllers operable to monitor and control a spin speed, a spin duration, a vacuum pressure and/or a temperature of the rotor forging at different areas of the rotor forging.

In another embodiment, each of the rim heater units is an induction heating unit.

In another embodiment, each of the induction heating units include a ceramic casing, a susceptor, a plurality of induction coils and a fluid purge cooler.

In another embodiment, the apparatus has a plurality of rim cooler units installed within the spin pit around the circumference of the rotor forging.

In another embodiment, each of the rim cooler units has a ceramic or metal casing and a plurality of coolant injector openings.

An advantage of a method and apparatus for temperature controlled pre-spinning of rotor forgings according to embodiments of the invention is that the method and apparatus enable superior material properties in the disk to be achieved by incorporating controlled heating and cooling as a part of the pre-spinning process.

A further advantage of a method and apparatus for temperature controlled pre-spinning of rotor forgings according to embodiments of the invention is that the effect of temperature distribution on the disk can be used to preferentially induce plasticity in both location and magnitude, thereby enabling optimization of the pattern of bulk residual stresses, enhancing the disk structural stability, durability, and strength and providing superior disk burst speed and fatigue life.

A further advantage of a method and apparatus for temperature controlled pre-spinning of rotor forgings according to embodiments of the invention is that the application of the controlled temperature pattern enables the generation of thermally induced stress fields on the rotor forging that are not attainable by merely adjusting the rotor forging shape or spin speed.

A method and apparatus for temperature controlled pre-spinning of rotor forgings according to embodiments of the invention varies the yield strength of the material in the targeted area of the rotor forging to promote localized yielding. By targeting the locations and magnitude of localized yielding, the temperature controlled pre-spin method and apparatus enable more alternatives to condition the bulk residual stress state and the material properties of the rotor forging.

Furthermore, by controlling the sequence, the rate of heating and/or cooling and the spin speed, the inventive pre-spin technique could also be the basis of novel material conditioning processes that may be superior to the existing combination of heat treatment processes in an oven.

Some anticipated advantages of a method and apparatus for temperature controlled pre-spinning of rotor forgings according to embodiments of the invention are that spinning ensures a more uniform application of heating and cooling on the rotor forgings disks being processed, which is a key issue for the existing heat treatment process. Combining the centrifugal load and the heat treatment process creates a novel material conditioning environment that could result in enhanced the strength and properties of the rotor forgings.

Moreover, the use of heat during the pre-spinning lessens the dependency on the mass and centrifugal load to generate required the yielding in the rotor forging. Leaner forgings not only save raw material cost, but also reduce the number of machining iterations to shape the forging into the final turbine disk shape. Eliminating two to four roughing machining operations can result in an estimated cost savings of $500-$1000 per piece.

By reducing uncertainties in the rotor forging (turbine disk) material properties, increased engine performance and turbine disk durability can be attained. Moreover, by combining the controlled and targeted heating and/or cooling with the pre-spin process, the disclosed method and apparatus offer a potential alternative to the traditional heat treatment process with known critical shortfalls. The additional variables possible with the disclosed method and apparatus allow more ways to optimize the rotor forging material properties.

### BRIEF DESCRIPTION OF THE DRAWINGS

Other advantages, benefits and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a schematic view of an apparatus for temperature controlled pre-spinning of rotor forgings according to an embodiment of the invention;

FIG. 2 shows a schematic view of the apparatus with a spin pit lid in a closed position;

FIG. 3 shows a schematic view of the apparatus with the spin pit lid in an open position;

FIG. 4 shows a cross-sectional view of a portion of the apparatus;

FIG. 5 shows a cross-sectional perspective view of the portion of the apparatus;

FIG. 6 shows an exploded view of a portion of the apparatus;

FIG. 7 shows a top perspective view of a portion of the apparatus;

FIG. 8 shows a schematic cross-sectional view of a portion of the apparatus with a schematic representation of the flow of coolant and power;

FIG. 9 shows a schematic cross-sectional view of a portion of the apparatus with a schematic representation of the coolant circulation and power systems;

FIG. 10 shows a perspective view of a portion of the apparatus with an exemplary rim heater unit and rim cooler unit;

FIG. 11 shows a perspective view of the exemplary rim cooler unit;

FIG. 12 shows a perspective view of the exemplary rim heater unit; and

FIG. 13 is a flow chart including steps of a method for controlled pre-spinning of rotor forgings according to embodiments of the invention.

### DETAILED DESCRIPTION OF THE DRAWINGS

An example of an apparatus and method for temperature controlled pre-spinning of rotor forgings is shown and described below. The system uses induction heating to apply heat onto a target disk feature in a controlled manner. In addition, the system may be operable to sequentially or simultaneously cool (via a jet of air or other medium) a targeted area of the disk in order to create a desired temperature profile on the spinning disk.

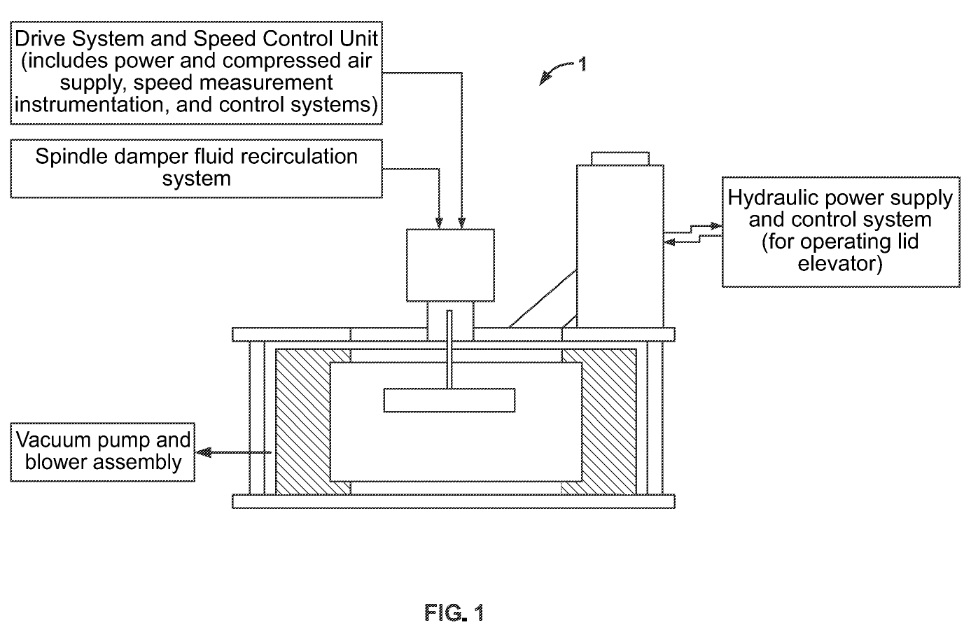

Referring now in detail to the drawings, and in particular FIGS. 1-3 show a schematic view of an apparatus 1 for temperature controlled pre-spinning of rotor forgings according to an embodiment of the invention. As shown, the apparatus 1 includes a spin pit 10 configured to receive a rotor forging 20 which is secured in the spin pit 10 with spin tooling elements 17. The rotor forging 20 may be used to form a disk of a gas turbine engine. The rotor forging 20 may be near net shape and include features corresponding to final machined features of the disk.

Apparatus 1 further includes a drive unit 11 and a transmission assembly 12 operable to spin the rotor forging 20 at a high rotational speed within the spin pit 10. The drive unit 11 may be an electric or a pneumatic motor. The transmission assembly 12 may include a spindle, a connector shaft, a spindle damper, a shaft damper and radial load bearings. One or more fluid recirculation systems may be provided for circulating fluid through the spindle damper and/or the shaft damper. Drive unit 11 and transmission assembly 12 may be operable to spin rotor forging 20 at a spin speed of 0 – 150,000 revolutions per minute (RPM).

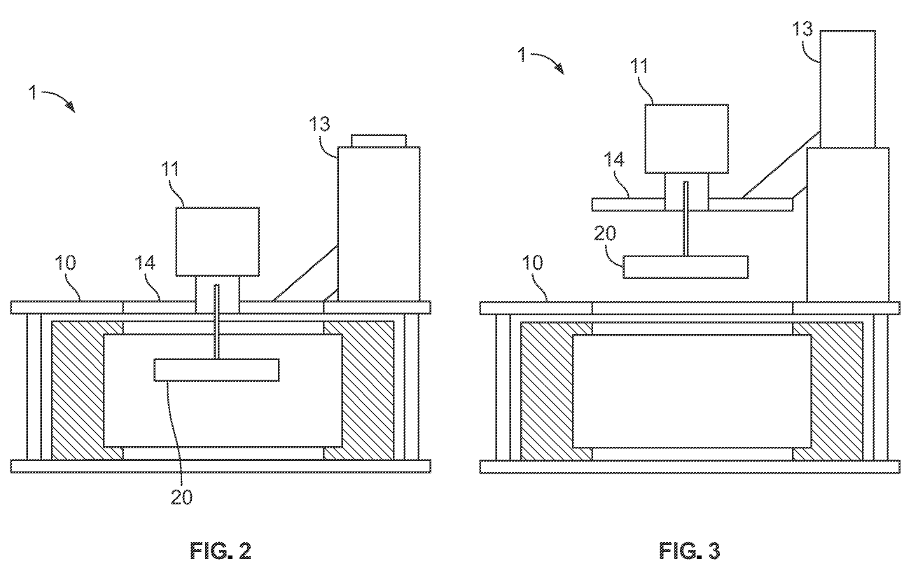

As shown schematically in FIG. 1, the apparatus 1 includes a number of systems and assemblies. The apparatus may include a hydraulic power supply and control system for operating a spin pit lid elevator 13 to raise and lower the spin pit lid 14. FIG. 2 shows the spin pit lid 14 in a closed position, which position corresponds to a position when the rotor forging 20 is being spun within the spin pit 10. FIG. 3 shows the spin pit lid 14 in an open position, which position corresponds to a position when the rotor forging 20 is being installed in or removed from the spin pit 10.

As shown schematically in FIG. 1, apparatus 1 further includes a vacuum pump and blower assembly for creating vacuum in spin pit 10. The vacuum may be operable to create a vacuum pressure of less than 600 mTorr, for example a vacuum pressure of 400 mTorr.

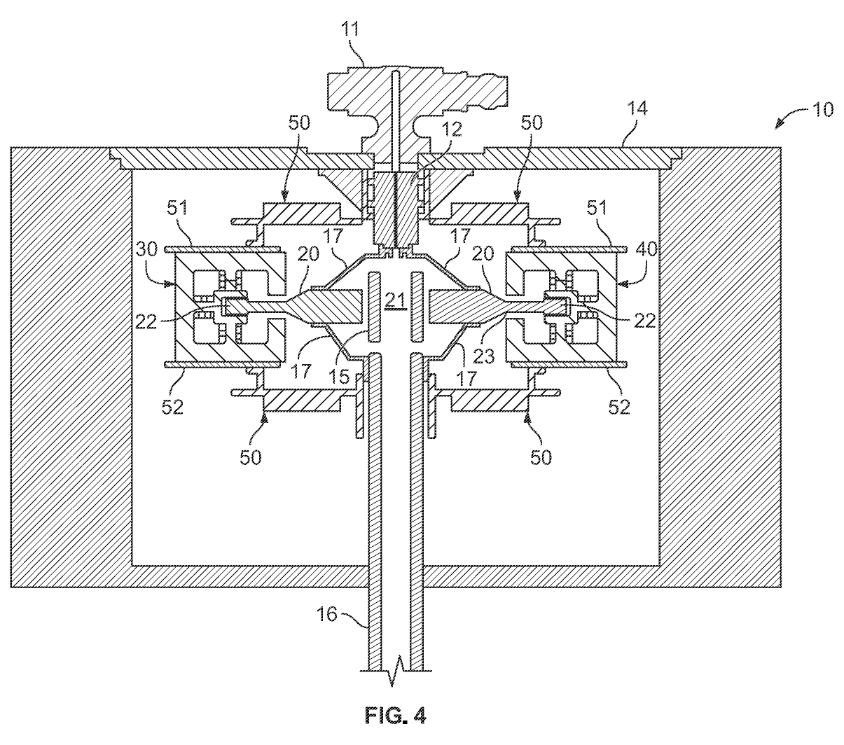

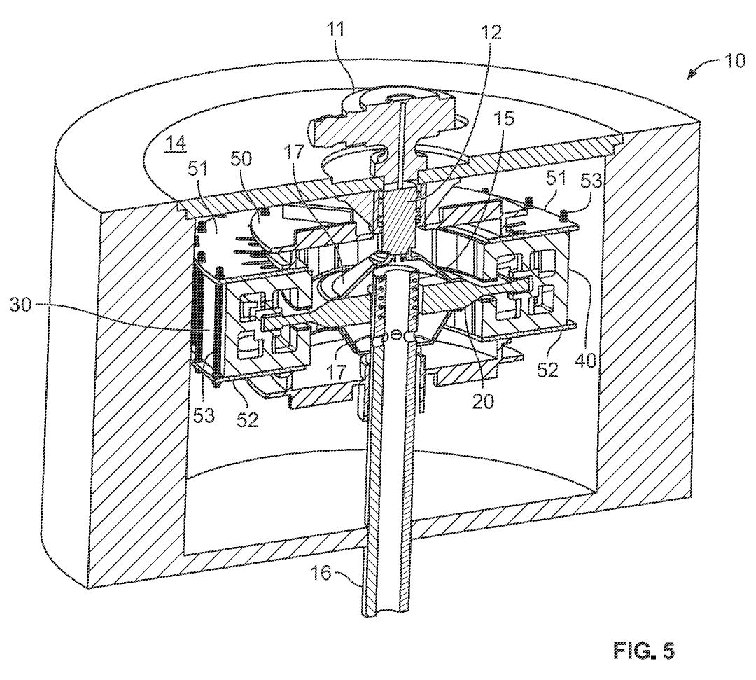

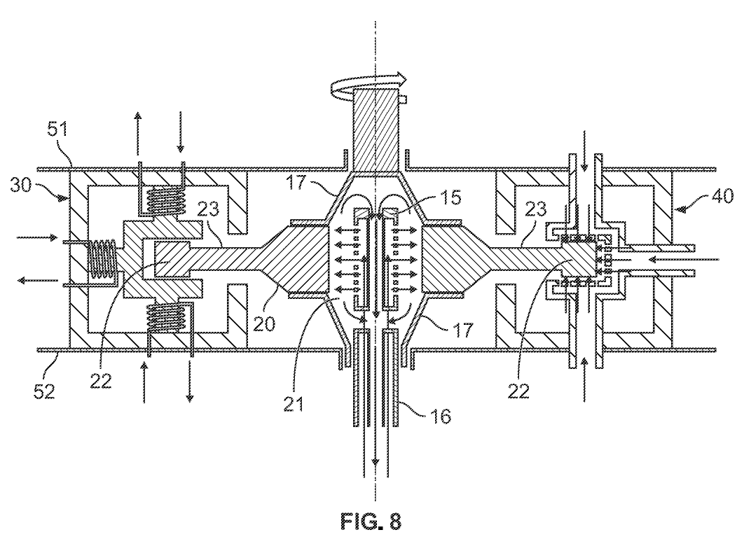

As shown in FIGS. 4-6, rotor forging 20 has a central bore 21 and apparatus 1 has a coolant pipe 15 configured to extend through the central bore 21 of the rotor forging. The apparatus further includes a bore coolant assembly 16 operable to circulate coolant through the coolant pipe 15 for cooling the central bore 21 of the rotor forging 20 to a predetermined temperature. The coolant can be a fluid medium, i.e., a liquid or a gas Bore coolant assembly 16 may include an outer bore cooler injector tube and an inner bore cooler exhaust tube as well as associated controls operable to cool the area about the inner bore 21 of the rotor forging 20 to a temperature in the range of -321 degrees Fahrenheit to 2,300 degrees Fahrenheit. For example, bore coolant assembly 16 may be set to an initial set point of 70 degrees Fahrenheit and to provide a target cooled temperature in the area of the inner bore 21 of 500 degrees Fahrenheit. The flow of coolant via the bore coolant assembly 16 is shown schematically in FIG. 8.

As shown schematically in FIG. 1, apparatus 1 includes one or more controllers operable to monitor and control the spin speed, spin duration, vacuum pressure, heating, cooling and/or the temperature of the rotor forging 20 at different areas of the rotor forging 20.

The apparatus 1 further includes a plurality of rim heater units 30 installed within the spin pit 10 around a circumference 22 of the rotor forging 20 for heating an area about the circumference 22 of the rotor forging 20. Likewise, apparatus 1 may optionally include a plurality of rim cooler units 40 installed within the spin pit 10 around the circumference 22 of the rotor forging 20 for cooling an area about the circumference 22 of the rotor forging 20. The plurality of rim heater units 30 and rim cooler units 40 may be collectively operable to cool or heat an area about the circumference 22 of the rotor forging 20 to a temperature range of - 321 °F to 2,300 °F. Additionally, the rim cooler units 40 may be operable to rapidly cool or quench the rotor forging 20 from a heated temperature.

In certain circumstances, it may be desirable to heat the central bore region 21 of the rotor forging 20 so the range of temperatures would be the same for both the rim and bore regions. In such a case, additional bore heater units (not shown) which can be similar in structure to the rim heater units 30 can be installed.

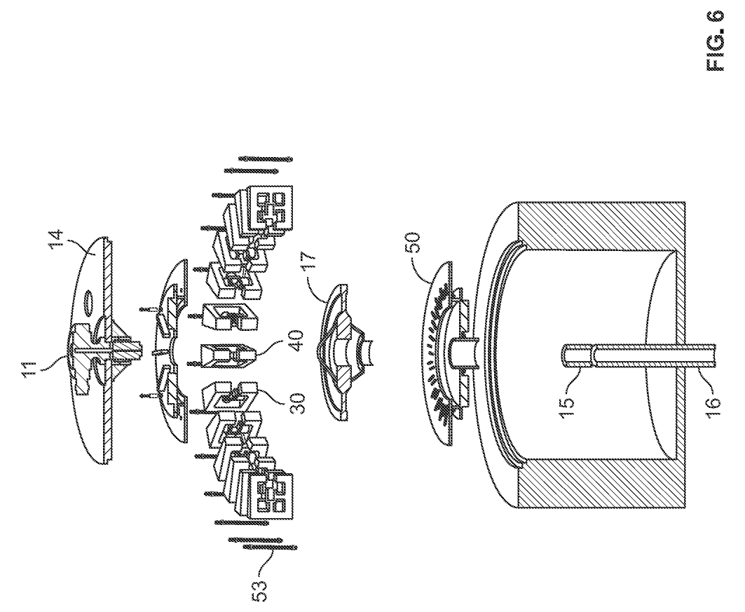

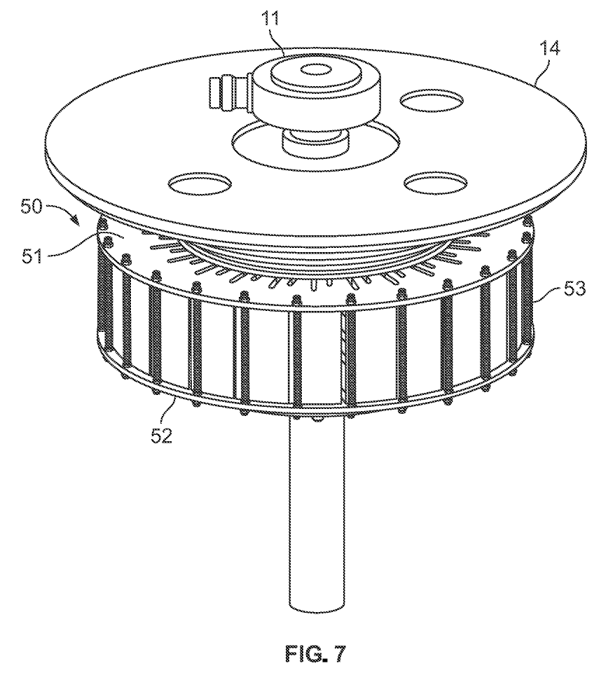

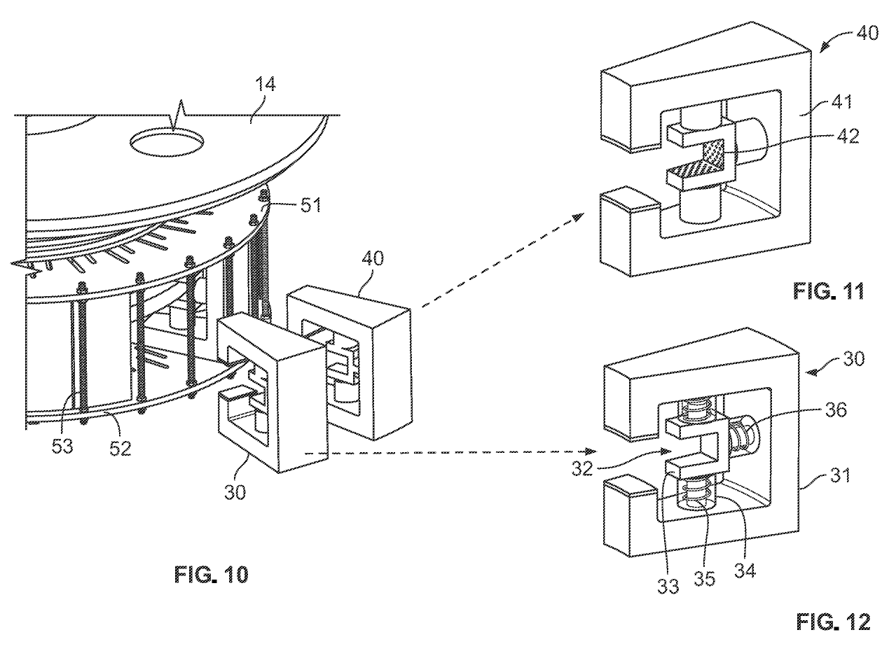

The rim heater units 30 and, if present, the rim cooler units 40 are installed in an appropriate arrangement and combination in accordance with the particular rotor forging 20 being treated. In a selected embodiment, rim heater units 30 and rim cooler units 40 are arranged in an alternating manner around the circumference of the rotor forging 20, as shown. for example in FIGS. 6, 7 and 10. The rim heater units 30 and the rim cooler units 40 may be mounted around the circumference of the rotor forging 20 using a thermal control chamber support structure 50 configured to receive and secure the rim heater units 30 and/or rim cooler units 40. Thermal control chamber support structure may include for example a circular upper plate 51 and a circular lower support plate 52 connected on their respective edges with a plurality of spaced apart elongated fastening elements 53.

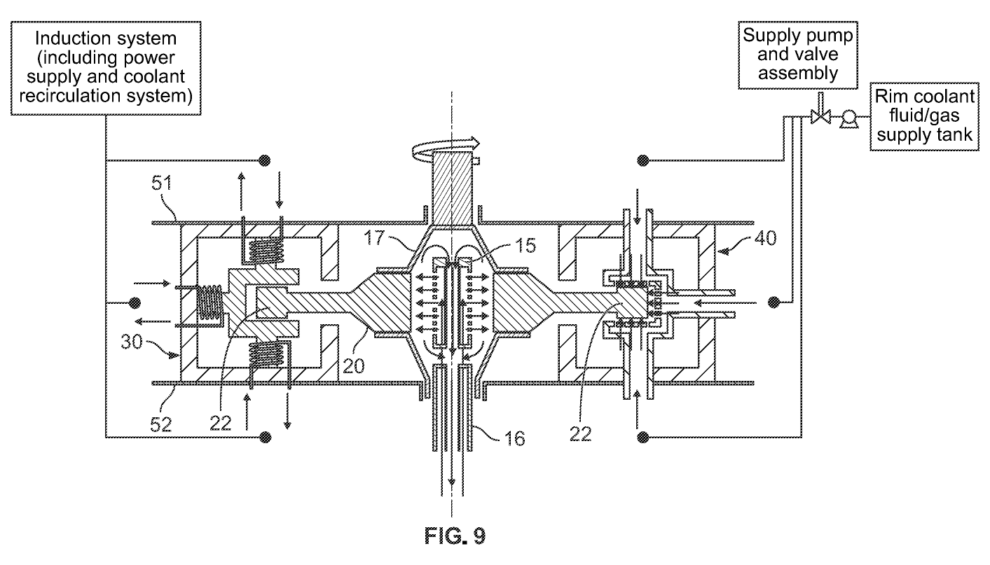

One or more of the rim heater units 30 may be an induction heating unit. As shown in FIG. 12, an induction heating unit can include a ceramic casing 31. Ceramic casing 31 encloses one or more susceptors 32. Susceptors 32 can be formed from a graphite-based material and may be in the form of a C-shaped body 33 and one or more, for example three, cylindrical bodies 34 around which respective induction coils 35 are arranged. The induction coils 35 can be actively cooled using a fluid purge cooler 36 which circulates coolant through the induction coil or coils 35. FIGS. 8 and 9 show a schematic representation of the flow of power and coolant to and from the rim heater units 30.

As shown in FIG. 11, one or more of the rim cooler units 40 may include a ceramic or metal casing 41 and a plurality of coolant injector openings 42 operatively connected to a supply of rim coolant fluid (liquid or gas) and a supply pump and valve assembly. FIGS. 8 and 9 show a schematic representation of the flow of coolant to and from the rim cooler units 40.

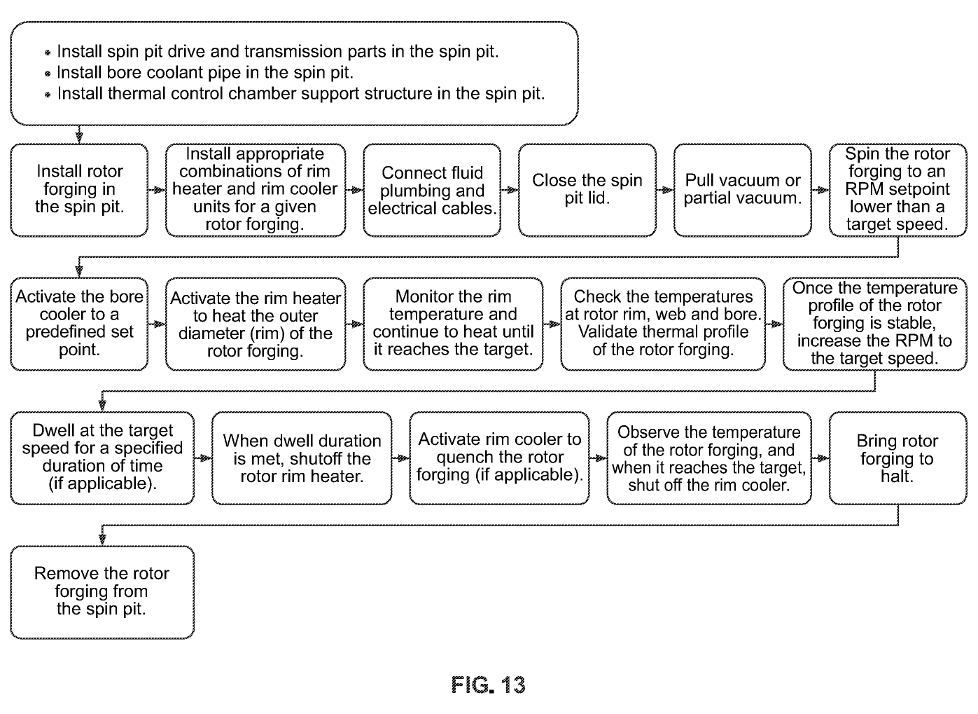

FIG. 13 is a flow chart including steps of a method for controlled pre-spinning of rotor forgings according to embodiments of the invention.

In particular, a method for temperature controlled pre-spinning of rotor forgings according to an embodiment of the invention includes the step of providing a pre-spin machine 1 having a drive unit 11 and a transmission assembly 12 operable to spin a rotor forging 20 at a high rotational speed, for example a rotational speed of up to 150,000 revolutions per minute (RPM), a spin pit 10, a coolant pipe 15 configured to extend through a central bore 21 of the rotor forging 20, a bore coolant assembly 16 operable to circulate coolant through the coolant pipe 15, a vacuum pump operable to create a vacuum in the spin pit and one or more controllers operable to monitor and control one or more of a spin speed, a spin duration, a vacuum pressure and a temperature of the rotor forging at different areas of the rotor forging 20.

The rotor forging 20 is mounted in the spin pit 10 of the pre-spin machine 1 using, for example, spin tooling elements 17 and a plurality of rim heater units 30 are installed around a circumference of the rotor forging 20.

The spin pit 10 is closed, for example using a spin pit elevator 13 and a vacuum is created in the spin pit 10 with the vacuum pump, for example a vacuum of 400 mTorr or less than 600 mTorr or any suitable vacuum pressure. The rotor forging 20 is spun to a rotational speed lower than a target speed, for example a rotational speed of 1000 RPM or any suitable speed, using the drive unit 11, transmission assembly 12 and associated controller.

The central bore 21 of the rotor forging 20 is cooled to a predetermined temperature using the bore coolant assembly 16 and the rim heater units 30 are activated to heat an area about the circumference of the rotor forging 20.

A temperature of the area about the circumference 22 of the rotor forging 20 is monitored and the area is heated until the temperature of the area reaches a target temperature, for example a target temperature of 1,850 degrees Fahrenheit or any suitable target temperature.

The temperature at the area 22 about the circumference of the rotor forging 20, a temperature at a web 23 of the rotor forging 20 and a temperature at the central bore 21 of the rotor forging 20 are monitored until a predetermined stable temperature profile of the rotor forging 20 is reached.

The rotational speed of the rotor forging 20 is increased to the target speed, for example a rotational speed of 30,000 RPM or any suitable speed, using the drive unit 11, transmission assembly 12 and associated controller. The rim heater units 30 are then deactivated and, the rotation of the rotor forging 20 is stopped and the rotor forging 20 is removed from the spin pit.

One or more of the rim heater units 30 may be induction heating units having a ceramic casing 31, a susceptor 32, a plurality of induction coils 35 and a fluid purge cooler 36.

The rotor forging 20 may be maintained at the target speed for a specified dwell duration time, for example zero to twenty-four hours, in particular two hours, and the rim heater units are deactivated when the specified dwell duration time is met.

Rim cooler units 40 can be installed around the circumference 22 of the rotor forging 20. The plurality of rim heater units 30 and rim cooler units 20 may be collectively operable to cool or heat the area about the circumference 22 of the rotor forging 20 to a temperature range of - 321 °F to 2,300 °F. The rim cooler units may be activated and operable to cool the rotor forging 20 to a target cooled temperature of between 70 and 500 degrees Fahrenheit and/or to quench the rotor forging 20 .

At least one of the temperature at the area about the circumference 22 of the rotor forging 20, the temperature at the web 23 of the rotor forging 20 and the temperature at the central bore 21 of the rotor forging 20 may be monitored until a predetermined temperature is reached and then the rim cooler units 40 are deactivated.

Although a number of embodiments of the present invention have been shown and described, it is contemplated that many changes and modifications may be made thereunto without departing from the spirit and scope of the invention. For example, it is contemplated that the apparatus and method described herein could provide a novel material conditioning process for other applications.

What is claimed is:

1. A method for temperature controlled pre-spinning of rotor forgings comprising the steps of:
providing a pre-spin machine having a drive unit and a transmission assembly operable to spin a rotor forging at a high rotational speed, a spin pit, a coolant pipe configured to extend through a central bore of the rotor forging, a bore coolant assembly operable to circulate coolant through the coolant pipe, a vacuum pump operable to create a vacuum in the spin pit and one or more controllers operable to monitor and control one or more of a spin speed, a spin duration, a vacuum pressure and a temperature of the rotor forging at different areas of the rotor forging;
mounting the rotor forging in the spin pit of the pre-spin machine;
installing a plurality of rim heater units around a circumference of the rotor forging;
closing the spin pit and creating a vacuum in the spin pit with the vacuum pump;
spinning the rotor forging to a rotational speed lower than a target speed;
cooling the central bore of the rotor forging to a predetermined temperature using the bore coolant assembly;
activating the rim heater units to heat an area about the circumference of the rotor forging;
monitoring a temperature of the area about the circumference of the rotor forging and continuing to heat the area until the temperature of the area reaches a target temperature;
monitoring the temperature at the area about the circumference of the rotor forging, a temperature at a web of the rotor forging and a temperature at the central bore of the rotor forging until a predetermined stable temperature profile of the rotor forging is reached;
increasing the rotational speed of the rotor forging to the target speed;
deactivating the rim heater units;
stopping a rotation of the rotor forging; and
removing the rotor forging from the spin pit.

2. The method according to claim 1, wherein the step of installing the plurality of rim heater units comprises installing a plurality of induction heating units, wherein each induction heating unit comprises a ceramic casing, a susceptor, a plurality of induction coils and a fluid purge cooler.

3. The method according to claim 1, further comprising the step of maintaining the rotor forging at the target speed for a specified dwell duration time and wherein the step of deactivating the rim heater units is performed when the specified dwell duration time is met.

4. The method according to claim 3, wherein the specified dwell duration time at the target speed is in the range of 0 – 24 hours.

5. The method according to claim 1, further comprising the step of installing a plurality of rim cooler units around the circumference of the rotor forging.

6. The method according to claim 5, wherein the plurality of rim heater units and rim cooler units are collectively operable to cool or heat the area about the circumference of the rotor forging to a temperature range of - 321 degrees Fahrenheit F to 2,300 degrees Fahrenheit.

7. The method according to claim 5, further comprising the step of activating the rim cooler units to quench the rotor forging.

8. The method according to claim 7, further comprising the steps of monitoring at least one of the temperature at the area about the circumference of the rotor forging, the temperature at the web of the rotor forging and the temperature at the central bore of the rotor forging until a predetermined temperature is reached and then deactivating the rim cooler units.

9. The method according to claim 1, wherein the vacuum created in the spin pit has a vacuum pressure of less than 600 mTorr.

10. The method according to claim 1 wherein the rotor forging is spun at a rotational speed of 0 – 150,000 revolutions per minute.

11. An apparatus for temperature controlled pre-spinning of rotor forgings comprising:
a spin pit configured to receive a rotor forging;
a drive unit and a transmission assembly operable to spin the rotor forging at a high rotational speed within the spin pit;
a coolant pipe configured to extend through a central bore of the rotor forging;
a bore coolant assembly operable to circulate coolant through the coolant pipe;
a vacuum pump operable to create a vacuum in the spin pit;
a plurality of rim heater units installed within the spin pit around a circumference of the rotor forging; and
one or more controllers operable to monitor and control one or more of a spin speed, a spin duration, a vacuum pressure and a temperature of the rotor forging at different areas of the rotor forging.

12. The apparatus according to claim 11, wherein each of the plurality of rim heater units comprises an induction heating unit.

13. The apparatus according to claim 12, wherein the induction heating unit comprises a ceramic casing, a susceptor, a plurality of induction coils and a fluid purge cooler.

14. The apparatus according to claim 11, further comprising a plurality of rim cooler units installed within the spin pit around the circumference of the rotor forging.

15. The apparatus according to claim 14, wherein each of the plurality of rim cooler units comprises a ceramic or metal casing and a plurality of coolant injector openings.
